(19) United States
(12) Patent Application Publication
(10) Pub. No.: US 2007/0156811 A1
(43) Pub. Date: Jul. 5, 2007

(54) System with user interface for sending / receiving messages during a conference session

(75) Inventors: Mukul Jain, San Jose, CA (US); Vinod Katkam, San Jose, CA (US); Randall B. Baird, Austin, TX (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/325,215

(22) Filed: Jan. 3, 2006

(51) Int. Cl. G06F 15/16

(52) U.S. Cl. 709/204

(57) ABSTRACT

A conferencing system includes a conferencing module that includes a digital signal processor to mix audio signals received from conference participants, and a messaging manager module coupled with the conferencing module. the messaging manager module allocating a memory space for each conference participant, the memory space for storing a message, the conferencing module delivering the message as either speech or text, notification and receipt of the message occurring without disturbance to a remaining group of the conference participants. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

The present invention relates generally to the fields of data networks and communication systems; more specifically, to systems and methods aimed at managing conference sessions for groups of individuals communicating over a telephony network.

### BACKGROUND OF THE INVENTION

Conferencing systems and methods, in which participants communicate in a conference session or meeting over existing voice and data networks, have been in existence for some time. Recent examples of conference calling systems include U.S. Pat. No. 6,865,540, which teaches a method and apparatus for providing group calls via the Internet; U.S. Pat. No. 6,876,734, which teaches an Internet-enabled conferencing system accommodating public switched telephone network (PSTN) and Internet Protocol (IP) traffic; U.S. Pat. No. 6,931,001, which discloses a system for interconnecting packet-switched and circuit-switched voice communications; and U.S. Pat. No. 6,671,262, which teaches a system with conference servers for combining IP packet streams in a conference call into combined packet streams, such that the combined IP packet stream utilizes no more bandwidth than each of the original packet streams.

A variety of different features and approaches for scheduling, control, and management of conference call sessions are also known. For instance, a conferencing system that facilitates a conference call by enabling a participant in the call session to determine and categorize the identities of the other participants is taught in U.S. Pat. No. 6,931,113. A conference calling system in which each participant may individually control incoming audio streams from other participants, and in which participants may communicate privately with each other in the context of the conference call, is disclosed in U.S. Pat. No. 6,501,739. U.S. Pat. No. 6,816,469 teaches an IP telephony network and PSTN network that allows one or more call waiting callers to dynamically join in an existing multiple party conference call session.

In addition, commercially-available IP communication system products such as Cisco's MeetingPlace™ conferencing application allow users to schedule meeting conferences in advance or, alternatively, to set up conferences immediately by dialing out to participant parties. Cisco MeetingPlace™ is typically deployed on a corporate network behind the firewall, and facilitates scheduling of business conferences from a touch-tone or voice over IP (VOIP) telephone, or a computer, using various software clients, such as Microsoft® Outlook, or a web browser.

Often times during a meeting or conference session certain participants want to exchange messages or engage in discussions without disturbing the other participants of the conference session. For instance, in the middle of a conference session several participants may want to have a sidebar conversation to discuss some important topic. Existing conferencing systems such as Cisco's MeetingPlace software product allow a subset of meeting participants to enter a “breakout” session or “room” in which individuals can establish their own private communication group session apart from the main conference session by simply pressing a predetermined keypad code or sequence (e.g., by pressing #1(1-9)). In the case where conference participants are in front of a PC, then they can communicate using an instant messaging (IM) client or similar tool to invite selected participants to enter a breakout session.

One problem that arises in prior art conferencing systems, however, is that often time participants have dialed into the conference session using a telephone device, such as a voice over Internet Protocol (VoIP) phone, rather than from a PC. In such cases, an invitation sent to a telephone participant to join a breakout session typically produces an audible signal or tone (e.g., voice interruption, ringing, beeping, etc.) that disturbs the other meeting participants.

Some conferencing systems support question and answer (Q&A) sessions, wherein participants (usually in listen-mode only) may send questions to a queue without interrupting the conference flow. But in these systems the questions are commonly submitted via a non-telephony interface from a computer (e.g., Web, email, IM, etc.). Additionally, in conference systems with Q&A session capabilities the questions and answers are typically heard by all participants in the meeting, which is different from sending and receiving offline messages between specified participants without disturbing the other participants to the conference session.

Various mechanisms also exist for leaving an offline message to notify the other attendees that a certain participant will be absent from a scheduled meeting or conference session. In Cisco's MeetingPlace™ software product, for example, this type of offline message is heard by every participant as they join the conference session. What is missing from the prior art, however, is a mechanism for sending an offline message to participants who have already dialed in using a telephone device while the conference session is in progress and without disturbing the other participants.

What is needed therefore is a conferencing system and method that overcomes the drawbacks of the prior art and which facilitates the sending of offline messages to one or more participants during a conference session without disturbing the other participants, regardless of device used to dial into the session.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a conceptual diagram of a conferencing system in accordance with one embodiment of the present invention.

FIG. 2 is a flowchart diagram that illustrates a method of operation according to one embodiment of the present invention.

FIG. 3 illustrates a user interface window associated with an application running on a PC of a user in accordance with one embodiment of the present invention.

FIG. 4 is an Internet Protocol (IP) telephone device with a display window that may be utilized to send/receive messages during a conference session in accordance with one embodiment of the present invention.

FIG. 5 is a flowchart diagram that illustrates a decision algorithm for sending a message to a participant during a conference session in accordance with one embodiment of the present invention.

### DETAILED DESCRIPTION

A conferencing system and method that allows a meeting participant to send/receive offline messages to/from any other meeting participant during a conference session without disturbing the other participants to the session is described. In the following description specific details are set forth, such as device types, system configurations, protocols, methods, etc., in order to provide a thorough understanding of the present invention. However, persons having ordinary skill in the relevant arts will appreciate that these specific details may not be needed to practice the present invention.

According to one embodiment of the present invention, a conferencing system and method is provided in which a user interface (e.g., graphical, touch, or voice) is utilized by participants for sending and receiving messages during a conference session. When a participant (i.e., user) is logged into the system, a conferencing module or application adds a special “invite to breakout” soft key to the user's telephone device. When the user presses this softkey on his telephone device the user is presented with a conference participant list. The user may then select desired recipients and then send an offline message inviting those recipients to join a breakout session. The invitation may be in the form of a pre-configured request. Each recipient can either accept or reject the invitation by pressing an appropriate key, e.g., by pressing an “accept” or “reject” soft key or by sending a corresponding Dual-Tone Multi-Frequency (DTMF) signal via the keypad. Message recipients that accept the invitation are automatically transferred or moved into the specified breakout room or session. In a specific implementation, the breakout room specified in the invitation message is automatically selected by a messaging manager program or module based on availability.

It is appreciated that the media path for the conference participants may include audio (voice) and video transmissions across a variety of different networks (e.g., Internet, intranet, PSTN, etc.), protocols (e.g., IP, Asynchronous Transfer Mode (ATM), Point-to-Point Protocol (PPP)), with connections that span across multiple services, systems, and devices (e.g., private branch exchange (PBX) systems, VoIP gateways, etc.). In a specific embodiment, the present invention may be implemented by software or hardware (firmware) installed in an IP communications system that includes components such as Cisco System's IP Communicator, Call Manager, MeetingPlace, Softphone (a PC that has phone capabilities installed), and other IP phone/communication products. Alternative embodiments of the present invention may be implemented in PBX, telephony, telephone, and other telecommunications systems.

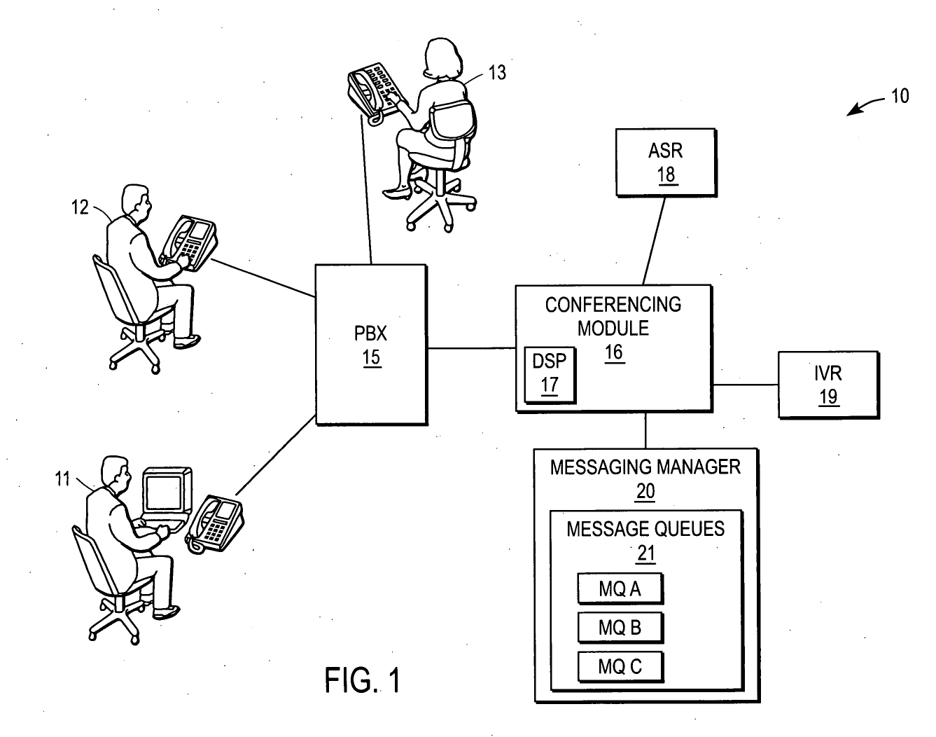

Referring to FIG. 1, an exemplary conferencing system 10 in accordance with one embodiment of the present invention is shown including a conference module 16 (e.g., a server) coupled with an corporate intranet network/PBX system 15. PBX system 15 may comprise either a time division multiplexing (TDM)-based or packet-network (e.g., VoIP)-based system. Conference module 16 may include a digital signal processor (DSP) 17 that mixes audio signals received from each of the conference or meeting participants, e.g., individual conference participants 11-13, and possibly from an interactive voice response (IVR) system 19. Participants 11-13 are shown connected with corporate intranet/PBX system 15 via various communication devices. For example, participant 11 is shown connected via a PC and an IP telephone device that has a display window with softkey functionality; participant 12. is shown connected via an IP telephone device that has a display window with softkeys; and participant 13 is shown connected via a non-IP telephone device without display window or softkey functionality.

In the embodiment shown, conference module 16 is also shown connected with a natural language automatic speech recognition (ASR) module 18 for interpreting and parsing speech of the participants, and a messaging manager module or server 20 that includes a set of memory spaces or message queues 21 for storing/holding messages sent by a participant and awaiting retrieval by the intended recipients. In one embodiment, messaging manager module 20 may use the speech recognition system to collect the list of names of message recipients. For instance, the messaging manager unit may automatically generate the speech-recognition-grammar based on the list of participants present in the meeting. Messaging manager 20 may also utilize or incorporate standard speech-to-text (STT) and text-to-speech (TTS) converter modules. It is appreciated that ASR module 18, messaging manager 20, IVR unit 19, and other modules/units may be incorporated into conferencing module 16, or included in other components of system 10. (Whether integrated together or implemented as separate components, module 16, ASR 18, IVR 19 and messaging manager 20 may be collectively referred to as a conferencing subsystem.)

Practitioners in the arts will understand that each of the component modules and units shown in FIG. 1 may be implemented by hardware, firmware, or software component elements that implement the various functions described herein.

In one embodiment, messaging manager 20, upon starting a meeting or conference session, creates or allocates a temporary message queue for each participant that joins the meeting. In FIG. 1, three message queues (MQ_{A}, MQ_{B}, and MQ_{c}) are shown for holding messages sent to participants 11-13, respectively. For instance, once participants 11-13 have joined the conference session and participant 12 wants to send a message to both participants 11 and 13, participant 12 sends an offline message to the message queue of participants 11 and 13, i.e., MQ_{A} and MQ_{c}, respectively. After the message has been sent and stored in message queues 21, participants 11 and 13 are notified via a message indicator. The message indicator may comprise an IM message to a recipient logged onto a PC, a special message tone (e.g., a “beep-beep” sound) mixed into the media stream sent from conferencing module 16 to the recipient(s), a text display message sent to the display window of the recipient's telephone device, some other visual indication (e.g., a flashing light) sent to the recipient's telephone device, a whisper tone alert (e.g., “You have a message”) mixed in the media stream sent to the recipient's phone device, or other sensory indicators.

It is appreciated that more than one type of message indicator may be utilized at any time to notify a participant that a message is waiting for them. That is, in certain implementations, a combination of alerts or indicators may be utilized to notify the recipient(s) that a message is waiting for them. Furthermore, even though in this example the three conference participants shown in FIG. 1 are involved in the message sending/retrieval process, it is appreciated that other persons (not shown) may participant in the conference session. These other participants, who may be referred to as a remaining group of participants, do not receive notifications or messages intended for other participants and therefore are not disturbed by the sending/receiving of messages to/from participants 11-13.

In the above-described embodiment, after the participant listens to their message, the message is deleted from message queue 21 by messaging manager 20. Also, once a participant leaves the meeting application (i.e., drops out of the conference session) his or her message queue is deactivated or deleted.

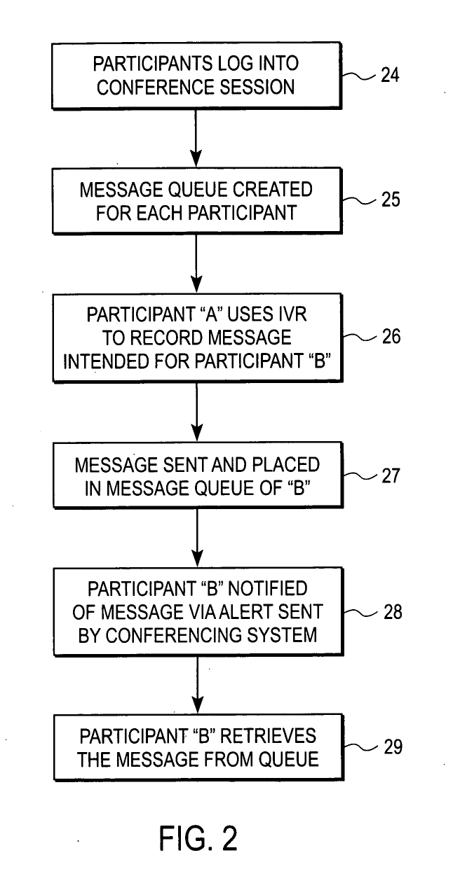

FIG. 2 is a flowchart diagram that illustrates an exemplary method of operation according to one embodiment of the present invention. The process starts (block 24) with the meeting attendees or participants dialing or logging into the conference session. Participants may dial-in from a variety of different devices, for example, from a touch-tone or IP telephone devices or from a computer with telephone functionality. Upon joining the conference session, a message queue is created for each individual participant (block 25).

Messages may be sent/received anytime during the conference session by any of the conference participants. By way of example, block 26 in FIG. 2 shows participant “A” using an IVR send menu to record an offline message that he wants to send. A predefined selection key (e.g., #62) on the user's telephone device may be utilized to take the user to the IVR menu on or connected to the conferencing module. After recording the message, participant “A” is given a choice to select the intended recipient(s), which, in this example is participant “B”. After confirming the selected recipients, the message is placed in the message queue reserved for participant “B” (block 27). In other embodiments, the voice message may be recorded after the recipients have been selected and confirmed. In the event that participant “A” is near a PC, he may alternatively use a Web browser or other user interface to select the one or more intended message recipients.

Regardless of how the message recipients are chosen, once selected, participant “A” may send the message using any one of a variety of mechanisms, including voice, keypad, softkey, or mouse button (“right-click”) commands. If the message is a text message and recipient is using a device incapable of presenting text (e.g., a non-IP telephone device without a display window) then the message manager unit may convert the message to a voice prompt using a text-to-speech converter. The message may be stored either as text or as digitally-recorded speech in the recipient's message queue (block 27).

After the message has been sent and placed in the appropriate message queue(s), the message recipients are notified of the availability of the message using one or more of the different message indicators or alerts described above (block 28). At that point, the recipient(s) may receive the message in a variety of different ways, depending on the device(s) available to the recipient (block 29). For example, a participant who has access to a touch-tone telephone may, at any time, press #69 to receive the message. Pressing the appropriate keypad command which would take him to the message manager's receive IVR menu. The recipient would then interact with IVR menu script to play the message, after which time the message is deleted from his queue.

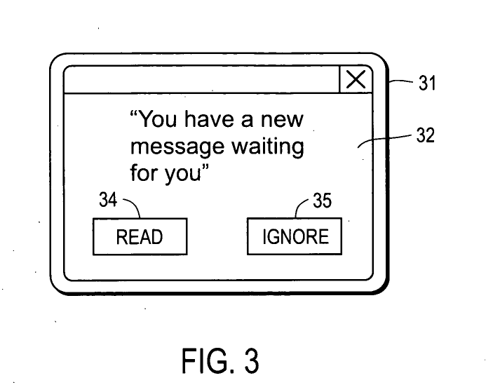

In the case a message recipient who is logged onto a PC that is running an IM client or tool, the message notification may be an IM message that pops up in a window on the screen of their PC. By way of example, FIG. 3 illustrates a pop-up window 32 on a display screen 31 of a PC with a text notification “You have a message waiting for you”; The recipient of this notification may read the message by clicking on the “Read” button 34, or ignore the message by clicking on the “Ignore” button 35. Alternatively, window 32 may include a Uniform Resource Locator (URL) hypertext link, or some other connection link, that allows the user to play (speech) or display (text) the message. Additional information, such as the time that the message was sent, who the message is from, etc., may also be included various fields of window 32.

In certain embodiments, a participant may send a message to invite another participant to enter a breakout session that includes a piece of explanatory text in a subject field that is typically communicated via IM. The conferencing system may detect that the receiving participant (i.e., invitee) is dialed into the conference session through a telephone device or connection (e.g., a voice (POTS) connection) that does not accommodate a subject field. In such a case, the conferencing module may utilize a text-to-speech (TTS) converter to transmit the subject field and text message to the POTS invitee as speech. The conferencing system may also accommodate an inviter participant who is dialed in via a voice-only connection, wherein the inviter records his invitation as speech and the system converts that speech to a text message that may be delivered to the invitee via IM or a display screen of an IP phone.

The graphical user interface (GUI) shown in FIG. 3 may be generated by software (i.e., code) running the user's PC. In other cases, the GUI may comprise a collaborative web-based application that is accessed by the browser software running on the user's PC. In other instances, GUI 13 may comprise a downloaded application, or other forms of computer-executable code that may be loaded or accessed by a participant's PC.

As discussed previously, if the message recipient does not have a PC that he is logged into, or is not running an IM tool, message notification may occur via a whisper tone alert message, a periodic beeping tone, blinking light, and/or a text message displayed on a display screen or window of the recipient's telephone device. In another embodiment, the message manager may not wait for the recipient to retrieve the message; instead, the message manager may directly whisper the message to the recipient via their telephone in addition to placing the message into the message queue. In certain embodiments, the sender may also be provided with control over the type of notification or message delivery mechanism to be used. For instance, the sender may tag the offline message by marking it directly “whisperable” to the recipient, thereby obviating the need for retrieval by the recipient.

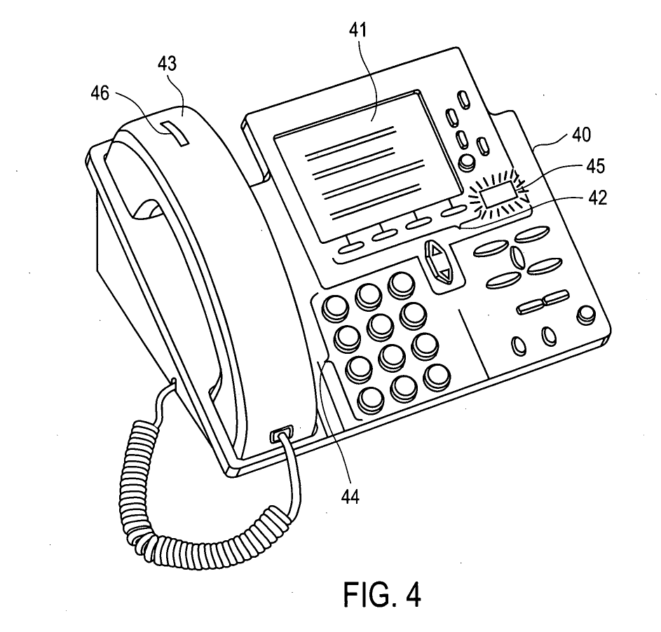

FIG. 4 is a perspective view of an IP phone that may be utilized by a participant who dials into a conference session in accordance with one embodiment of the present invention. The IP telephone shown in FIG. 4 includes a liquid crystal display (LCD) screen 41, dynamic softkeys 42, a handset 43, and an alphanumerical keypad 44. In one embodiment, softkeys 22 may be used for sending, receiving, or ignoring messages. For example, a text message on display screen 41 similar to that shown in FIG. 3 may be used to notify the recipient that a message is waiting for them. Softkeys 42 may be configured as single-button inputs to allow the user to either accept (i.e., listen or read) or reject the message.

The IP telephone shown in FIG. 4 also includes message indicator lights 45 and 46 that may provide a visual notification (e.g., flash) when a message is waiting for the recipient. In certain implementations, a text message may be displayed on screen 41 in addition to flashing of lights 45 & 46 when a message is waiting to be read or heard.

In yet another embodiment, the conferencing application may be configured to obtain presence information from each of the conference participants in order to determine the appropriate mechanism or channel to present the message and/or notification to the recipient. For example, conferencing module 16 may determine that since participant 13 (see FIG. 1) has dialed into the conference through a telephone device without display capabilities, the appropriate notification channel may be a visual message indicator or whisper message. On the other hand, participant 12 may be notified via a text message displayed on his IP telephone, with the phone's softkeys being configured for one or more appropriate responses. In the case of participant 11, the message notification and delivery channels may include an IM pop-up message.

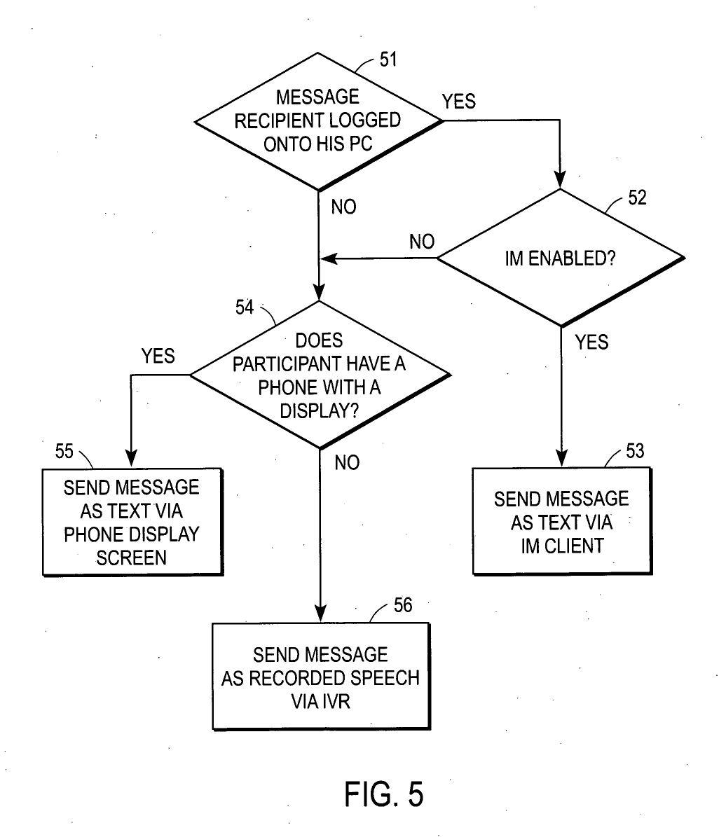

FIG. 5 is a flowchart diagram that illustrates an intelligent decision algorithm for sending a message to a participant during a conference session in accordance with one embodiment of the present invention. The algorithm of FIG. 5 may be implemented in a software (or firmware) program running on a processor of the module associated with the conferencing application, and may be used in conjunction with user preference settings for selecting an appropriate channel, or hierarchy of channels, for message notification and delivery.

The example of FIG. 5 begins by with an inquiry whether the recipient is currently logged onto his PC (block 51). If the recipient is indeed logged on, the flow proceeds to inquire whether IM is currently enabled on the recipient's PC (block 52); if so, the message is sent as text via the IM client as described above. If the recipient is not logged into-his PC, or has IM disabled, the next inquiry in the process is whether the conference participant who is the intended recipient of the message has dialed into the session via a telephone device with display capabilities (block 54). If the answer is yes, the message is sent as text displayed on the telephone's display screen (block 55). If, on the other hand, the recipient called into the conference using a telephone device without a display screen, the message may be sent as a recorded speech that may be retrieved using the IVR menu associated with the conferencing system (block 56). In other embodiments, the message may be whispered directly to the recipient.

In an alternative embodiment, where the message was created using an IM client and stored in the recipient's message queue as text, the conferencing system may convert the message into audible speech using a TTS converter for delivery to a receiving participant who is dialed into the conference session via a voice-only connection.

It should be understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. For example, the conference messaging mechanism of the present invention is not limited to simply sending messages or invitations for the purpose of inviting participants into a breakout room; rather, the conference messaging system and method of the present invention may be used for sending any sort of message during a conference session. For example, a participant may want to tell another participant that he intends to drop out of the meeting shortly and to request that the other person meet him in his office after the conference session is over. Accordingly, the specification and drawings are to be regarded in an illustrative rather than a restrictive sense.

We claim:

1. A system for conferencing a plurality of conference participants in a conference session comprising:
a conferencing module operable to record a message from a sending conference participant intended for delivery to one or more recipient conference participants that includes at least one conference participant connected to the conference session via a telephone device that lacks instant messaging (IM) capability, and to notify the one or more recipient conference participants of the message, the conferencing module also being operable to allow the one or more recipient conference participants to receive the message as either speech or text; and
an interactive voice response (IVR) unit coupled with the conferencing module that allows the sending conference participant to select the one or more recipient conference participants, to record the message, and to send the message, wherein notification and receipt of the message by the one or more recipient conference participants occurs without disturbance to a remaining group of the conference participants to the conference session.

2. The system of claim 1 wherein the conferencing module includes a digital signal processor that mixes audio signals received from each of the conference participants.

3. The system of claim 1 wherein the conference participants are coupled with the conferencing module through a private branch exchange (PBX) via corresponding communication devices.

4. The system of claim 3 wherein the conferencing module includes a processor which executes an algorithm that determines one or more appropriate communication channels for notifying the one or more recipient conference participants of the message, and/or communicating the message to the one or more recipient conference participants, based on presence information of the corresponding communication devices.

5. The system of claim 1 wherein the telephone device includes a screen for displaying text messages.

6. The system of claim 5 wherein the telephone device further comprises a plurality of softkey buttons, one or more of the softkey buttons being configured to facilitate immediate receipt of the message as text displayed on the screen.

7. The system of claim 5 wherein the telephone device further comprises a plurality of softkey buttons, one or more of the softkey buttons being configured to facilitate invitation the one or more recipient conference participants to enter a breakout session.

8. A system for conferencing a plurality of conference participants in a conference session comprising:
a conferencing module operable to store a text message from a sending conference participant intended for delivery to a recipient conference participant connected to the conference session via a voice-only connection; and
a text-to-speech (TTS) converter to translate the text message into an audible speech message prior to delivery to the recipient conference participant, wherein the conferencing module is further operable to deliver the audible speech message to the recipient conference participant without disturbing a remaining group of the conference participants to the conference session.

9. A conferencing system for conducting a conference session comprising:
a conferencing module that includes a digital signal processor to mix audio signals received from a plurality of conference participants, each of the conference participants dialing into the conference session via a communication device, at least one conference participant dialing into the conference session via a telephone device that lacks instant messaging (IM) capability;
a messaging manager module coupled with the conferencing module, the messaging manager being operable to allocate a memory space for each conference participant, the memory space for storing a message from a sending conference participant intended for a receiving conference-participant, the conference module being operable to send a notification to the receiving conference participant and for delivering the message as either speech or text in response to an acceptance command received from the receiving conference participant, wherein the notification and delivery of the message occurs without disturbance to a remaining group of the conference participants.

10. The conferencing system of claim 9 wherein the memory space comprises a message queue.

11. The conferencing system of claim 9 further comprising:
an interactive voice response (IVR) system coupled with the conferencing module that allows the sending conference participant to record the message and to select the receiving conference participant via the communication device of the receiving conference participant.

12. The conferencing system of claim 9 further comprising:
an automatic speech recognition (ASR) module coupled with the conferencing module, the ASR being operable to interpret and parse speech of the conference participants, and to collect a list of names of the conference participants.

13. The conferencing system of claim 9 wherein the telephone device comprises a plurality of softkey buttons, one or more of the softkey buttons being configured by the conferencing module to facilitate creation of the message and selection of the receiving conference participant by the sending conference participant.

14. The conferencing system of claim 9 wherein the conferencing module includes a processor which executes an algorithm that determines one or more appropriate communication channels for notifying the receiving conference participant of the message, and/or communicating the message to the receiving conference participant, based on presence information obtained from the communication device of the receiving conference participant.

15. A conferencing system for conducting a conference session comprising:
means for creating a message queue associated with each participant to the conference session; and
means for configuring a user interface of a first telephone device used by a sending participant to facilitate creation a message intended for a receiving participant, the message being either speech or text that is stored in the message queue associated with the receiving participant, and for configuring a user interface of a second telephone device of the receiving participant to facilitate listening or reading the message without disturbance to a remaining group of the participants to the conference session.

16. A processor-implemented method for messaging between participants to a conference session, comprising:
recording a message by a sending participant;
selecting, by the sending participant, a receiving participant for whom the message is intended;
storing the message in a memory space associated with the receiving participant;
notifying the receiving participant of the message;
accepting the message by the receiving participant;
reading or listening to the message to the receiving participant via a communication channel appropriate to a telephone device used by the receiving participant to dial into the conference session, the telephone device lacking instant messaging (IM) or web browser capabilities; and
wherein recording, notifying, accepting and reading or listening occurs without audible disturbance to a remaining group of the participants to the conference session.

17. The processor-implemented method of claim 16 wherein the message is a voice message recorded via an interactive voice response (IVR) system.

18. The processor-implemented method of claim 17 further comprising:
obtaining information about the telephone device; and
determining the communication channel based on a decision algorithm and the information about the telephone device.

19. The processor-implemented method of claim 17 further comprising:
converting the voice message to a text message; and
sending the text message to a display screen of the telephone device.

20. The processor-implemented method of claim 16 wherein notifying comprises sending a whisper message to the receiving participant.

21. The processor-implemented method of claim 16 wherein notifying comprises activating a message indicator of the telephone device of the receiving participant.

22. The processor-implemented method of claim 16 wherein the message indicator includes an illuminated light.
